(19) United States
(12) Patent Application Publication
(10) Pub. No.: US 2011/0146599 A1
(43) Pub. Date: Jun. 23, 2011

(54) HYDROGEN GENERATING SYSTEM

(76) Inventors: Stanley J. Sciban, Leawood, KS (US); Timothy L. Sellers, Holt, MO (US)

(21) Appl. No.: 12/642,163

(22) Filed: Dec. 18, 2009

(51) Int. Cl. F02B 43/10; C25B 9/04

(52) U.S. Cl. 123/3; 204/230.6

(57) ABSTRACT

The present invention provides control systems and methods for generating hydrogen gas by electrolysis. The electrolysis control system comprises an electronic controller including a shaped current waveform generator and a current control device coupled to the output thereof; at least one electrode assembly disposed within a housing adapted to store an electrolyte solution, each electrode assembly comprising an anode coupled to an electrical power source; and a cathode coupled to the current control device, wherein the shaped current waveform generator causes the current control device to periodically couple the cathode to ground to pass current though the electrolyte solution and generate hydrogen gas.

### FIELD OF THE INVENTION

The present invention relates to systems and methods for increasing the quantity of hydrogen and other gases created by electrolysis, and in particular, to apparatus and methods for more efficiently stimulating electrolysis electrodes to generate hydrogen gas for internal combustion engines.

### BACKGROUND OF THE INVENTION

The demand for energy has grown substantially over the past century and continues to grow at a staggering pace. One of the primary sources of energy has been the combustion of fossil fuels. However, the combustion of fossil fuels, which are formed of hydrocarbons, in internal combustion engines is usually incomplete, resulting in reduced efficiency and the introduction of various pollutants into the atmosphere.

Through incremental refinements in design, engine manufacturers have improved the fuel efficiency of internal combustion engines to a limited degree. As result, internal combustion engines manufactured today are more efficient and emit less pollutants than those produced in the past. However, significant advancements have not been realized.

In addition, increasing fuel costs and calls for cleaner forms of energy which do not threaten the environment, have prompted auto makers and engine manufacturers to explore sources of energy which do not rely on the combustion of fossil fuels. For example, auto makers have developed vehicles capable of operating on alternative fuels, such as electric power, natural gas and hydrogen fuel cells. However, these alternatives have only achieved limited success due technological limitations and cost. For example, each of these alternative technologies requires significant financial investment in new infrastructure (e.g., dedicated refueling stations). As a result, hydrocarbon-based fuels will continue to provide the basis for transportation for the foreseeable future. Therefore, the need remains to develop internal combustion engines that are more efficient.

In this regard, it is known that the use of hydrogen as a fuel, or fuel additive, increases the efficiency of internal combustion engines and reduces pollution. These advantages are believed to be the result of a more complete combustion caused by the presence of hydrogen in the combustion chamber. In addition, hydrogen combustion produces no carbon dioxide or other pollutants. However, prior attempts to commercialize hydrogen and other gases for use in internal combustion engines or industrial electrolysis applications have fallen short. For example, some systems have attempted to use a storage tank onboard a motor vehicle. However, hydrogen gas is flammable and difficult to store safely onboard a vehicle in sufficient quantity. Furthermore, these systems have required costly high pressure tanks and the availability of refill sites.

Therefore, there is a need for systems capable of efficiently generating large volumes of hydrogen as it is needed by the engine, or “on-demand.” Electrolysis, as a process, has established itself as the best economic and technological method of producing hydrogen on-demand in several industries. However, the current electrolysis processes have a higher than necessary demand for energy input which greatly diminishes the economic value of the gasses produced by the process. Thus, the opportunity for increased performance of the electrolysis systems, as disclosed herein, has economic value both from the aspect of return on investment and amount of gaseous product produced.

In addition, an on-demand hydrogen generation system, based upon the electrolysis of water, would eliminate the need to store large amounts of hydrogen and allay safety concerns. However, an electrolysis system is needed which provides consistent hydrogen production without thermal or current runaway. In particular, once normal operation is reached the system should be capable of being turned on and off multiple times and returning to the same current and excitation level. Further, such systems should maximize energy transfer between the electrical power source and the electrolysis cell.

### SUMMARY OF THE INVENTION

The system of the present invention features a low pressure, controlled and compact hydrogen injection unit which can be added to existing or future internal combustion engines in vehicles or stationary engine applications, which rely on fossil fuels, such as gasoline and diesel fuels, to reduce fuel consumption and emissions. The system provides highly efficient energy transfer between the electrical power source and the electrolysis units through the use of a shaped current waveform and a non-inductive load.

### BRIEF DESCRIPTION OF THE DRAWINGS

Exemplary embodiments of this invention will be described with reference to the accompanying Figures.

FIG. 1 is a perspective view of an embodiment of the system of the present invention.

FIG. 2 is a perspective view of an embodiment of the electrode assembly of the present invention.

FIG. 3 is a perspective view of a second embodiment of the electrode assembly of the present invention

FIG. 4 is a cross-section view of the reaction vessel of the present invention.

FIG. 5 is a perspective view of the electrolytic fluid agitation device of the present invention.

FIG. 6 is a perspective view of another embodiment of the electrode assembly of the present invention.

FIGS. 7(a)-7(g) are various embodiments of the placement of the ohmic load of the present invention.

FIG. 8 is a cross-section view of another embodiment of the system of the present invention.

FIG. 9 is waveform useful in illustrating the present invention.

FIG. 10 is schematic view of an embodiment of the electronic control circuit of the present invention.

### DETAILED DESCRIPTION OF THE EXEMPLARY EMBODIMENTS

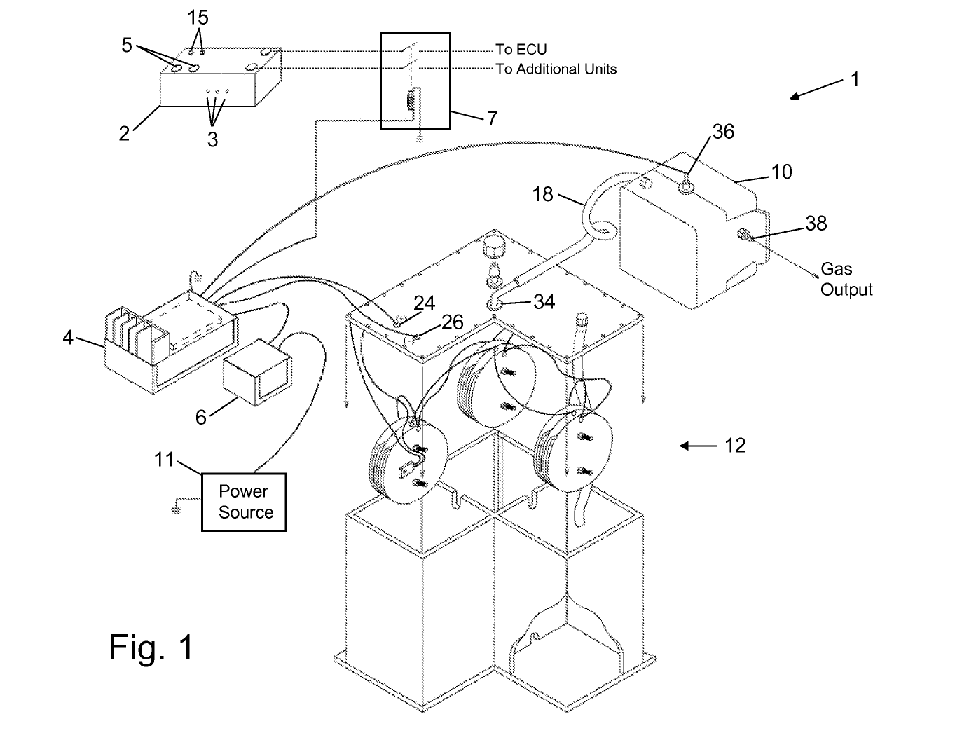

FIG. 1 provides an overview of a system for providing hydrogen gas to an internal combustion engine to improve the combustion process. The complete system is generally indicated with reference numeral 1, and comprises various electrical and electrolysis components. It will be appreciated that other configurations of the system 1 and its components are possible as long as they fulfill the desired function. In addition, the individual components of the system 1 (i.e. circuits, electrodes, ohmic load, etc.) may find applications beyond those described herein, including uses outside the field of electrolysis, internal combustion engines and hydrogen generation.

As shown in FIG. 1, the system 1 includes a system control 2 whose function is to provide the operator with control and status capabilities. For example, the system control 2 may include switches 15 to allow an operator to enable or bypass the system 1. Indicator lights 3 provide the operator with system status, including indications of whether the system 1 is active, disabled or a fault condition has occurred. In addition, the system control 2 allows integration of the system 1 into a vehicle's existing electronic control unit (“ECU”), preferably, with minimum or no modification. The system 1 may utilize the vehicle's existing engine sensors to measure, for example, manifold absolute pressure (“MAP”), mass air flow (“MAF”), exhaust oxygen levels, engine speed and/or throttle position. Selection will typically vary based upon the specific vehicle model into which the system 1 is integrated. As will be discussed further below, the output of one or more of these sensors may be used to automatically adjust the system 1 hydrogen output as engine and load conditions vary.

The system control 2 may also include mixture adjustment knobs 5 which allow the operator to set the richness and leanness of the fuel mixture into the engine. In particular, the mixture adjustment knobs 5 allow lowered fuel intake with hydrogen gas drawn into the combustion chamber. This allows the engine to produce equal power and lower emissions as compared to an engine running without hydrogen supplementation. Adjustment knobs 5 may comprise, for example, two potentiometers, one for low RPM function and one for high RPM function. Other methods and devices for manipulating a vehicle's air/fuel ratio are known to those skilled in the art.

The system control 2 is electrically coupled to the electronic control 4 which provides electrical power to a reaction vessel 8 (also known as an electrolysis cell), which contains electrodes and the electrolytic fluid necessary to generate hydrogen by electrolysis. In addition, the electronic control 4 monitors total current draw using current monitor 6. When an electrical potential is applied across the positive terminal 24 and the negative terminal 26 of the reaction vessel 8, hydrogen gas is generated by electrolysis and supplied to vessel output port 34. Hydrogen gas is transferred from the vessel output port 34 to gas reservoir 10 through transfer hose 18. Transfer hose 18 may be curled and, preferably, inclined to promote vapor condensation and drain-back of moisture into the reaction vessel 8.

Although possible to construct the system 1 without the gas reservoir 10 (i.e., supplying hydrogen gas directly from vessel 8 to the engine), a dedicated gas reservoir 10 provides a number of advantages. The gas reservoir 10 increases the availability of hydrogen during acceleration and compensates for varying load conditions (e.g., towing, passing, hills, etc). In addition, the gas reservoir 10 also serves as a condensation and vapor trap, providing a dryer hydrogen gas for combustion. The gas reservoir 10 may further include a vapor accumulation drain at its bottom to allow condensed catalysis fluid to be reclaimed and returned to the reaction vessel 8. An input vapor trap and output vapor trap (not shown) may be located at gas reservoir 10 entrance and exit for additional moisture removal. The gas reservoir 10 further serves as a logical attachment point for a hydrogen sensor 36. A pressure release valve (not shown) may also be incorporated into the gas reservoir 10. In operation, gas pressure within the gas reservoir 8 need not exceed 5 psi, greatly reducing safety concerns. The gas reservoir 10 also ensures that the system 1 operates continuously at approximately 5 PSI. Gas is drawn from gas reservoir 10, by engine vacuum, into the engine's air intake. The gas mixture is subsequently mixed with fuel and delivered to the combustion chamber.

It is further desirable to construct the system 1 to permit “fail-soft” operation. As used herein, the term “fail-soft” refers to a condition where the engine continues to operate, but without the benefit of hydrogen gas. To prevent the system 1 from running without gas output, or if gas reaction ceases, the hydrogen sensor 36 measures hydrogen levels at the gas reservoir 10. The hydrogen sensor 36 is monitored by the electronic control 4 which is adapted to disable the system should hydrogen output fall below a preset level. As shown in FIG. 1, the fail-soft function may be implemented using a master relay 7, which will return full engine control to the vehicle's ECU when a fault condition has occurred. The electronic control 4 may also monitor reaction vessel 8 input current and cause a fail-soft shutdown when the current draw approaches a predetermined upper limit. Once source current draw returns to normal levels, or the malfunction is corrected, the monitor may reset to restore the system 1 function.

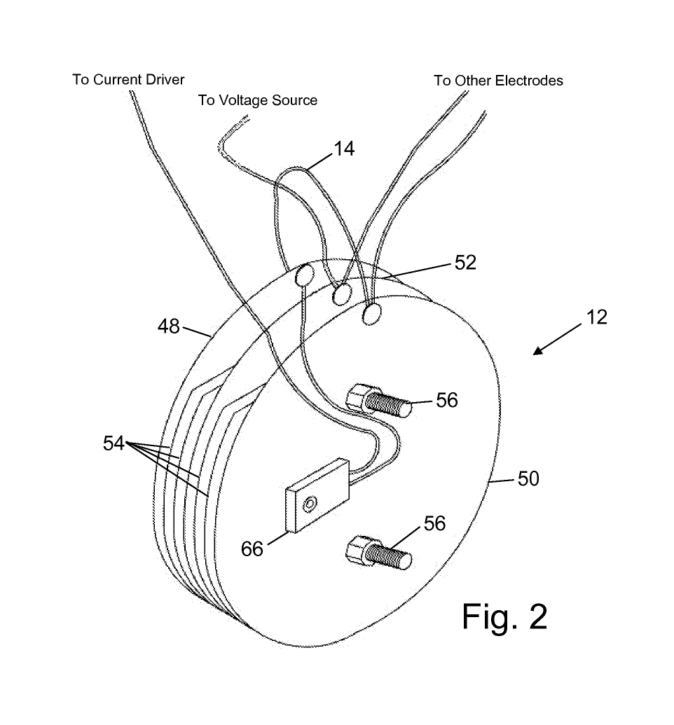

With reference to FIG. 2, an exploded view of the electrode assembly 12 of the hydrogen generation system 1 is shown. In one embodiment, an electrode assembly 12 is constructed of three electrically active electrodes, a first electrode 48, a second electrode 50 and a third electrode 52. The first electrode 48 and the second electrode 50 are fixed in place at the outside of the electrode assembly 12. These two electrodes 48 and 50 are electrically coupled by reaction resistant wires 14. Interposed between the first electrode 48 and the second electrode 50 is the third electrode 52. In a preferred embodiment, the active electrodes 48, 50 and 52 are positioned substantially parallel to one another and the spacing between the third electrode 52 and each of the first and second electrodes 48 and 50 is maintained, preferably, between 0.22 and 0.40 inches. In a preferred embodiment, and as described in the exemplary embodiments herein, the first and second electrodes 48, 50 function as the cathode and the third electrode 52 functions as the anode. However, alternative configurations may be provided.

The electrodes may be constructed from, for example, nickel-coated brass, carbon, stainless steel, nickel plated stainless steel, and other materials known in the art. In the embodiment shown in FIG. 2, each electrode preferably measures approximately 4.5 inches in diameter and is approximately 0.030 inches thick. While solid electrodes are shown, perforated or mesh electrodes may be substituted. In addition, while the electrodes shown in FIG. 2 are generally circular is shape, other shapes (square, rectangular, cylindrical, etc.) and configurations may be substituted.

Additionally, unconnected, electrically floating or neutral electrodes 54 may be interposed between the third electrode 52 and the first and second electrodes 48, 50. In the embodiment shown in FIG. 2, a total of four neutral electrodes 54 are utilized. In particular, two neutral electrodes 54 are interposed between the third electrode 52 and the first electrode 48 and two neutral electrodes 54 are interposed between the third electrode 52 and the second electrode 50. The neutral electrodes may be constructed of the same material as the active electrodes or other conductive materials. The electrodes which comprise electrode assembly 12 are secured together with non-conductive spacers (not shown) and a non-conductive pin 56 to lock the individual electrodes into a single assembly and maintain the electrodes in a fixed relationship to one another.

Among other benefits, the neutral electrodes 54 contribute to stabilizing the temperature of the electrolysis fluid by controlling eddy currents during high current periods. Additionally, the neutral electrodes 54 contribute to controlling current run-away and stimulation degradation. The neutral electrodes 54 further function as shields, neutralizing the space between the positive electrode 52 and negative electrodes 48 and 50. Also shown in FIG. 2 is an ohmic load 66, which is discussed in detail below.

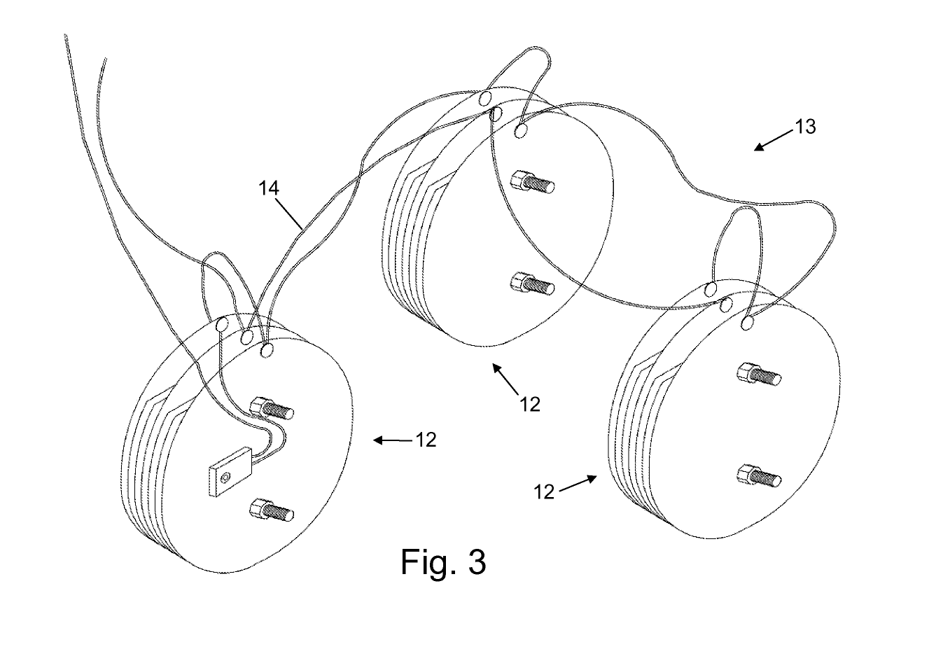

As shown in FIG. 3, three individual electrode assemblies 12 may be electrically interconnected to form a tri-electrode assembly 13. As shown, the individual electrode assemblies 12 are connected to each other, in parallel, using wires 14. Although three electrode assemblies 12 are shown, the number of interconnected electrode assemblies 12 may be scaled according to performance, gas and size requirements.

The system 1 may utilize aqueous electrolysis solutions comprising mixtures of water and potassium hydroxide, sodium bicarbonate, or other catalyst solutions apparent to those knowledgeable in the art. In a preferred embodiment the electrolysis solution is prepared by combining 14.5 grams of sodium hydroxide (NaOH) and 1 fluid ounce of hydrogen peroxide, per gallon of distilled water.

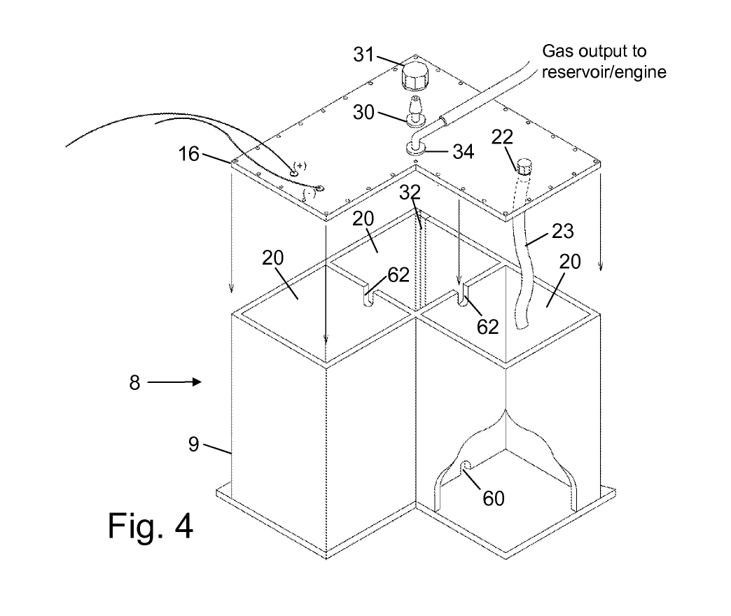

With reference to FIG. 4, an embodiment of the reaction vessel 8 of the system 1 is shown. The reaction vessel 8 is comprised of vessel body 9 and top plate 16. Vessel body 9 is divided into chambers 20, into which the individual electrode assemblies 12 are inserted. Vessel body 9 contains fluid channels 60 which allows electrolytic fluid levels to be maintained in equilibrium between chambers 20. Wire channels 62 allows electrical wires 14 to interconnect the electrode assemblies 12. In addition, wire channels 62 allow gas discharge from each of the chambers 20 to be drawn to the output port 34. The vessel body 9 may further include a fluid level viewing panel 32 for easily monitoring fluid levels.

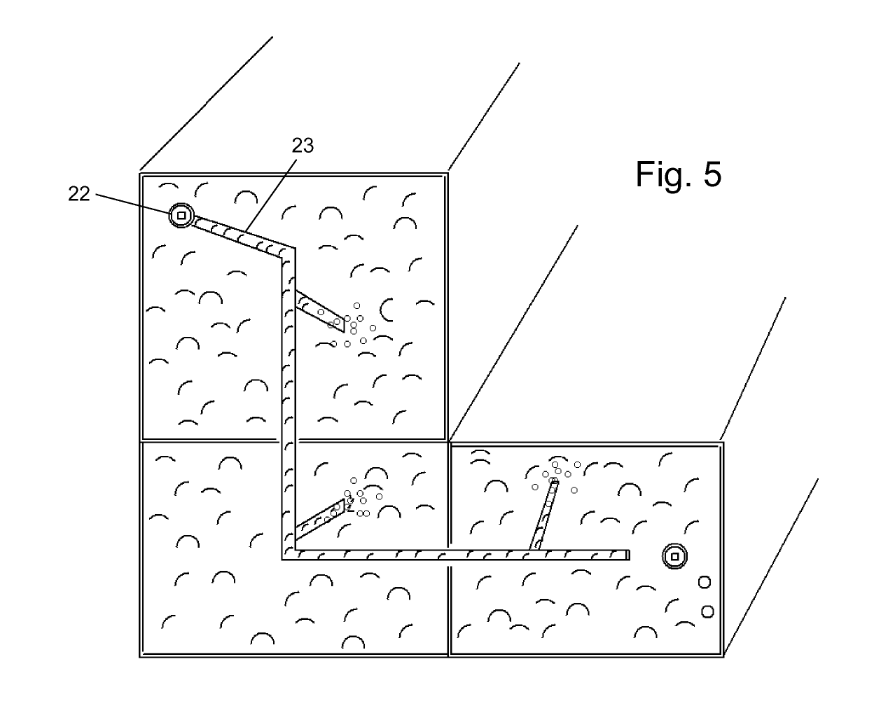

The top plate 16 includes a fill spout 30 to fill or top-up the reaction vessel 8 with the electrolysis fluid. A check valve (not shown) may be incorporated into fill spout 30 to relieve reaction vessel 8 overpressure and prevent the catalyst fluid from leaking, should a user fail to reinstall the fill cap 31. Air inlet control knob 22 may be used to regulate the reaction vessel's 8 output gas flow by varying air intake. Alternatively, an air pump or vacuum regulator with variable airflow control may be also be used to increase gas output pressure. Air inlet tube 23 is used to bring air to the bottom of the reaction vessel 8 to bubble the electrolysis solution, causing agitation of any suspended solution particles. In another embodiment, shown in FIG. 5, air inlet tube 23 may be perforated and shaped to further promote fluid agitation. Fluid agitation caused by incoming air also aids in the release of gas bubbles from the electrode assemblies 12. In this regard, hydrogen output has been found to increase appreciably when hydrogen bubbles formed on the surface of the electrodes are rapidly released from the surface as more working electrode surface is made available. Therefore, in addition to agitation caused by input air through air inlet tube 23 (as shown in FIGS. 4 and 5), additional agitation of the electrodes may be advantageous.

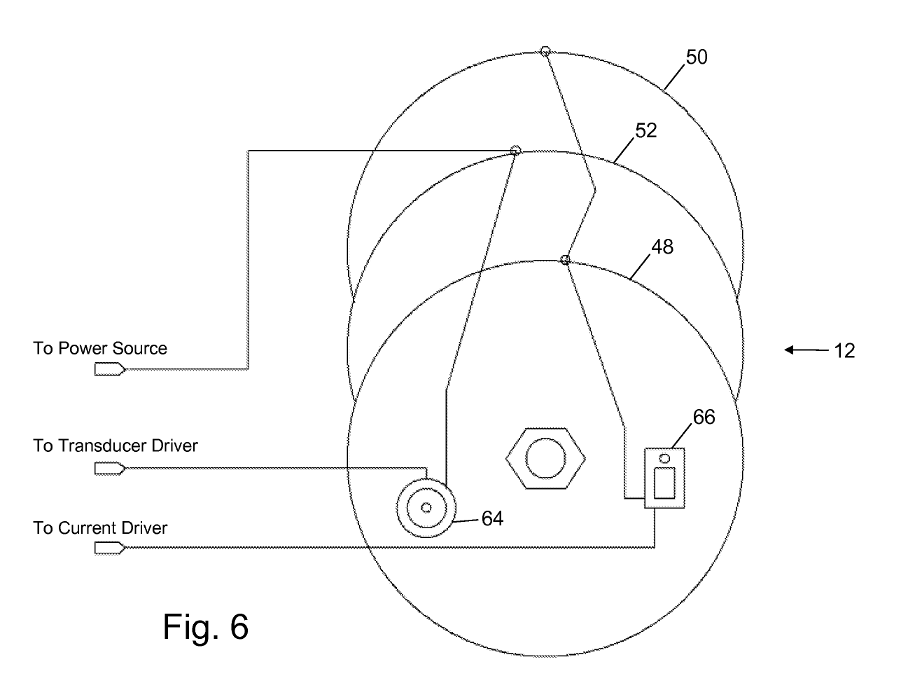

With reference to FIG. 6, another embodiment of the electrode assembly 12 of the system 1 is depicted which provides electrode agitation. As shown, a transducer 64 is mounted to the first electrode 48 of the electrode assembly 12. The transducer 64 may be an electromechanical device, electroacoustic device or any other device capable of inducing vibration into the electrodes. This addition allows the individual electrodes 48, 50, 52 to act as diaphragms. It has been found that the motion caused by the transducer 64, when pulsed at approximately 2 Hz to 100 Hz, allows almost instantaneous release of bubbles forming on the electrodes during the electrolysis process. As a result, bubbles of various sizes, including minute bubbles and micro bubbles, will be released. Rapid release of hydrogen bubbles from the electrode surfaces allows a greater amount of the electrode surface to remain in contact with the electrolysis solution during the electrolysis process. A detailed description of a circuit capable of driving the transducer 64 is discussed below.

FIG. 6 also illustrates the use of a non-inductive ohmic load resistor 66. It is generally known that electrodes immersed within an aqueous solution have no stable-state load. As a result, any application of voltage will cause an inconsistent current draw and inefficient power transfer to the electrodes, in particular during cold start-up of electrolysis. It has been found that a substantially non-inductive ohmic load resistor 66 assists the electronic control 4 by providing a constant impedance to the circuit. In operation, ohmic load 66 reduces electrode degradation and helps control runaway current by providing a stable ultra-low or low impedance load to the current control circuit during electrolysis. Furthermore, when used with a shaped current waveform (discussed below), the ohmic load 66 curbs overshoot and ringing, even at high current drive providing more efficient power delivery to the electrolysis process.

The ohmic load resistor 66 may be placed on the surface of one of the electrodes, as shown in FIG. 6. A thermally conductive paste (i.e., silicone heat sink material) between the ohmic load 66 body and the electrode may also be used. Connection is made in series with the anode or cathode, depending on design application. In addition, two ohmic loads may be provided, each in series with the anode and cathode. The ohmic load 66 leads should be insulated from one another as not to create alternative reaction paths. A range of 0.020 milliohms to 1.0 ohm will be applicable to most designs, with a preferred range of 0.050 to 0.075 ohms. An example of a resistor suitable for such a design, is the MP900 (or MP9000) Kool-Pak® Power Film Resistor, available from Caddock Electronics, Inc., Riverside, Calif.

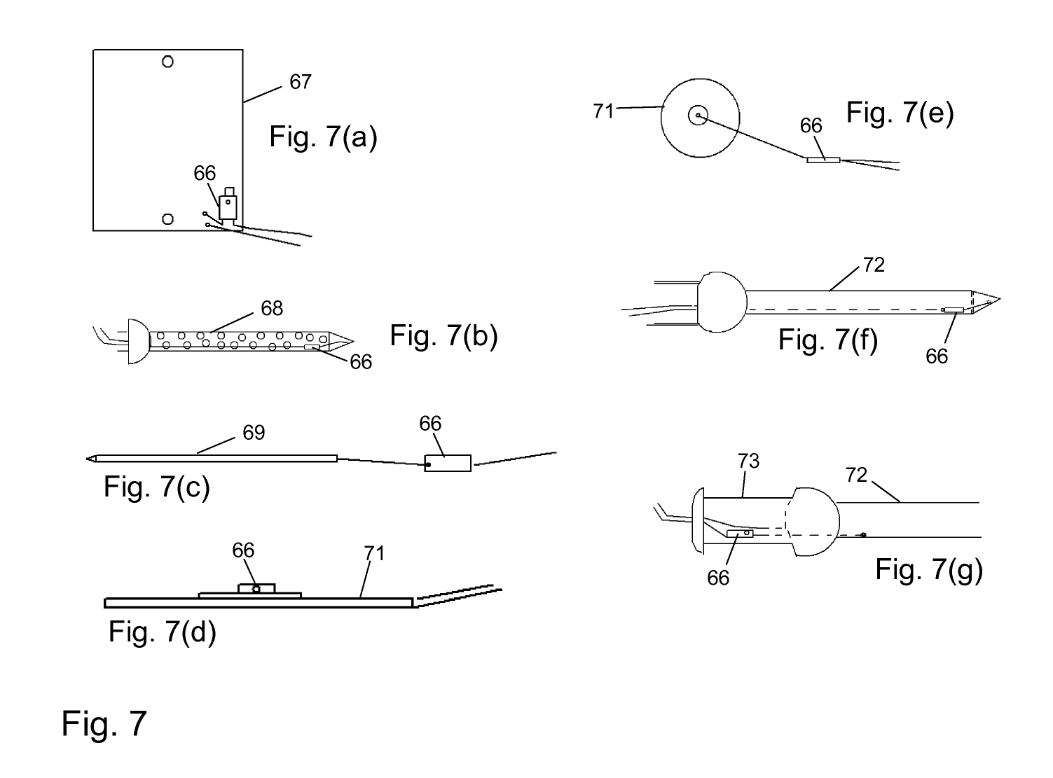

Alternative applications and configurations of the ohmic load resistor 66 are shown in FIG. 7. FIG. 7(a) depicts a rectangular electrode 67 with the ohmic load 66 mounted on its surface. FIG. 7(b) depicts a fluid vented electrode 68 with an internal ohmic load 66. FIG. 7(c) depicts a needle electrode 69 with an external ohmic load 66. FIG. 7(d) depicts a conductive rubber electrode 71 with an internal ohmic load 66. FIG. 7(e) depicts a conductive rubber electrode 71 with an external ohmic load 66. FIG. 7(f) depicts a hollow or solid cylinder electrode 72 with an internal ohmic load 66. FIG. 7(g) depicts a hollow cylinder electrode 72 with an ohmic load 66 mounted within an insulated handle 73. The ohmic load resistor can be used with most forms of electrodes in which a stimulus is applied. Applications include research, medical, electroplating, electrolysis, etc. and, particularly, applications requiring a pulsed stimulus in a aqueous solution.

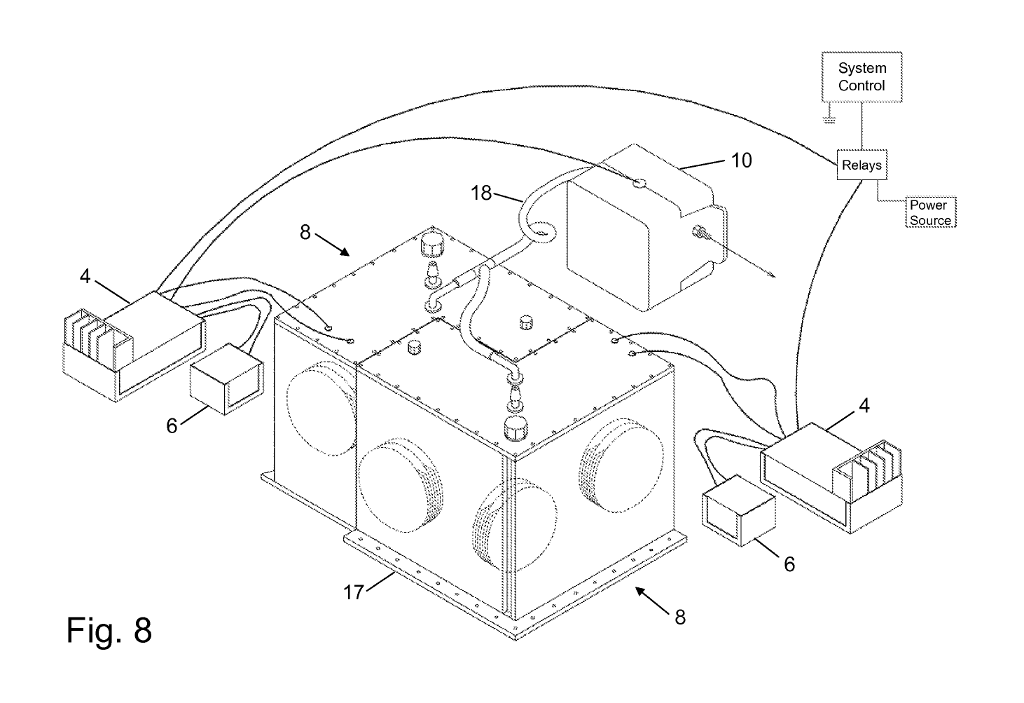

Another embodiment of the system 1 is shown in FIG. 8. In this embodiment, modularized reaction vessels 8 are configured to interlock with additional reaction vessels 8 to support larger hydrogen generation systems. The reaction vessels 8 may interconnect by vessel bottom plate 17 or by stacking reaction vessels. By way of example, the modules may be designed to be assembled in banks of one reaction vessel 8 (three electrode assemblies 12), two reaction vessels 8 (six electrode assemblies 12), three reaction vessels 8 (nine electrode assemblies), etc. Modularization presents a number of advantages, such as allowing a base unit to be adaptable to many different applications based on gas output requirements or engine displacement. For example, one reaction vessel 8 may be sufficient for four and six cylinder engines, while eight cylinder engines may require two reaction vessels. In addition, a modular design reduces manufacturing and maintenance costs.

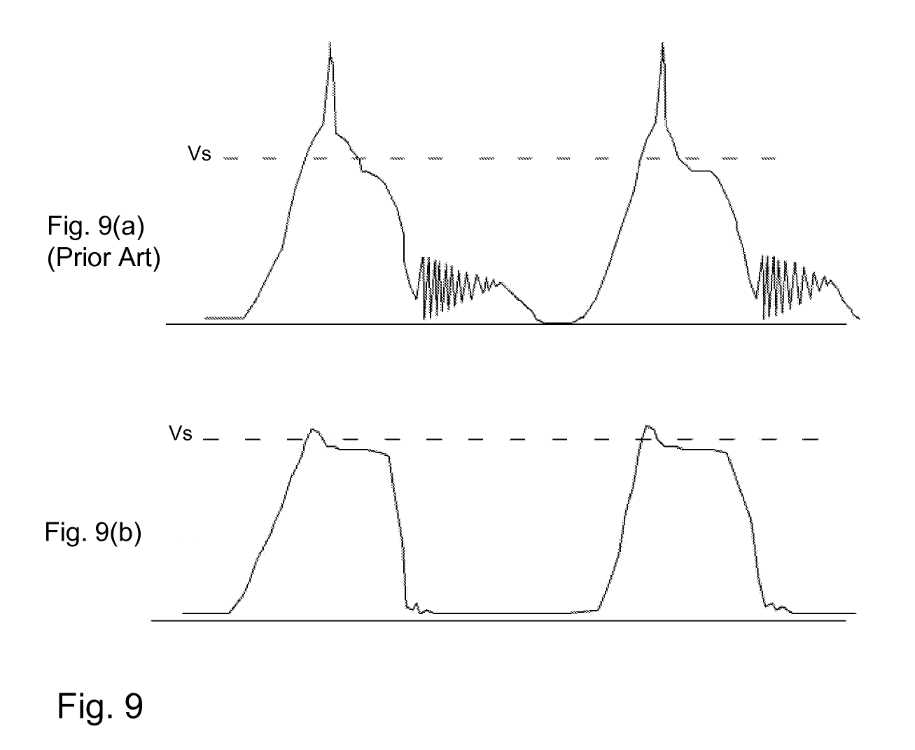

As discussed above, prior art systems have provided inefficient power transfer to the electrolysis cell. In this regard, it has been recognized by the inventors that one reason for such inefficiency in the prior art is that these systems relied on excitation waveforms having substantial overshoot and ringing. With reference to FIG. 9(a), a representative voltage waveform for a prior art electrolysis system is shown. As can be seen, an applied potential results in significant overshoot of the stable-state voltage, Vs. In addition, the waveform is plagued by ringing when the applied voltage drops to ground potential. Recognizing the problems caused by such overshoot and ringing, the present invention provides a shaped waveform, which substantially eliminates overshoot and ringing. A representative waveform of the present invention is shown in FIG. 9(b). As can be seen, only an insignificant amount of overshoot and ringing remain. For example, overshoot has been reduced by 90% and ringing has been minimized to about 5% of the applied voltage amplitude. Applied stimulus at high or very high currents with a shaped waveform and an appropriate ohmic load can deliver close to 23% average power efficiency increase. An exemplary electrical circuit, capable of providing a shaped waveform as shown in FIG. 9(b), is described below.

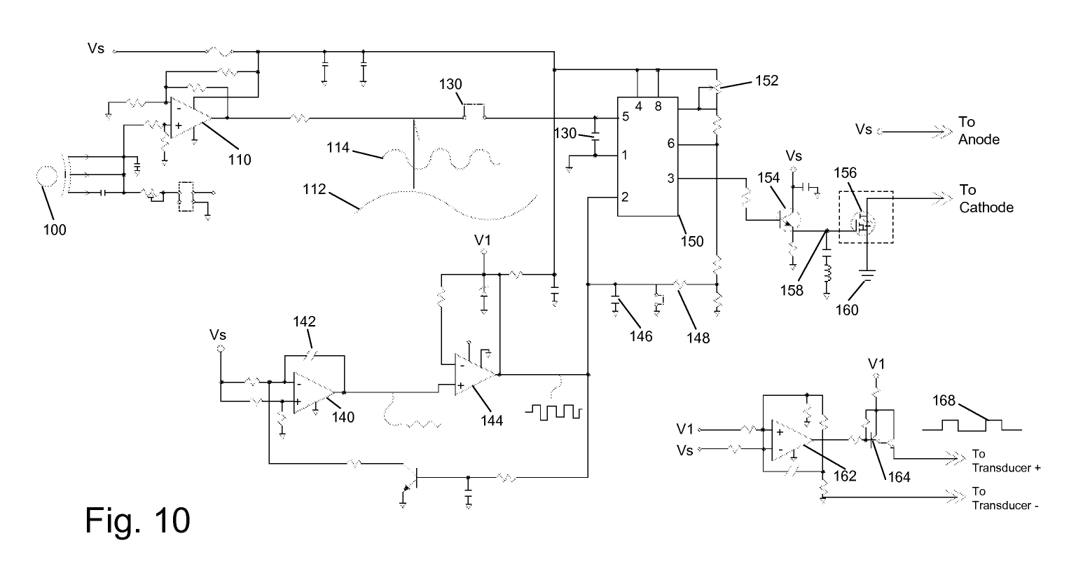

FIG. 10 is a schematic view of one embodiment of the electronic control 4 of the system. This particular control circuit may operate in two modes. In a first mode, a fixed frequency and duty cycle waveform is applied to the electrodes. In a second mode, the circuit generates, for example, a pulse width modulated waveform, which is proportional to input signals received from the engine ECU, and is applied to the electrode. This second mode allows current, as well as hydrogen production, to increase or decrease with engine RPM or load conditions.

In the first mode, where no engine sensor input is used, jumper 130 is removed. Timing pulse is created by an operational amplifier (“op-amp”) 140 (configured as an oscillator), where capacitor 142 is selected to create an output pulse on time of 0.027 ms. Average pulse off time is approximately 0.005 ms. Capacitor 142 is selected from the range of from 0.600 pf to 0.10 uf as required by electrode application; i.e.: size, spacing, current duty cycle, and other factors as needed for the specific application. In the circuit shown, a 750 pf capacitor is used. The output of op-amp 140 is buffered by op-amp 144 and is amplified for output to pulse timer 150. Op-amps 142 and 144 suitable for this application include, for example, the LM258, available from National Semiconductor, Santa Clara, Calif. Additionally, a pulse timer 150 suitable for this application includes, for example, the LM555 integrated circuit, also available from National Semiconductor.

The output of op-amp 144 is shaped and modified by capacitor 146 and resistor 148 to slope pulse edges and reduce ringing at timer 150 trigger (pin 2). Pulse timer 150 discharge (pin 7) is modified by potentiometer 152 to correct for component drift or tolerance issues. Input of timer 150 control (pin 5) is coupled to ground 160 by capacitor 132 when the fixed mode is desired and should be removed when the second mode is desired and jumper 130 is installed.

The shaped waveform output of timer 150 output (pin 3) is fed to transistor 154 to drive input gate of the high current driver 156. The high current driver 156 can be ganged, at connection point 158, (2 to 10 devices) to provide very high currents, if properly heat sunk. In this example current driver 156 is rated at 64 amps at T_{C}=100 Degrees C. A suitable current driver 156 includes, for example, the IRFP054 Power MOSFET, available from International Rectifier, El Segundo, Calif. The component values above provide continuous 28-30 amps current draw at 12VDC as used in hydrogen electrolysis driving three electrode cells in parallel.

The circuit “on” time is provided when current driver 156 conducts, providing the attached electrode(s) a current path to ground 160. It has been discovered that the selective switching of the electrode(s) to ground 160, as opposed to switching the power supply positive voltage (Vs), allows greater control and stability and minimizes RFI. In addition, power supply positive voltage which may be connected to other equipment is further isolated and less affected by RFI or current pull-down in this configuration.

In the second mode, where drive requirements need varying electrode currents, jumper 130 is installed and one or more engine sensors are connected to the circuit. The sensor 100 output is sent to op-amp 110 whose configuration is shown for a varying resistance input from the engine sensor. This configuration may be modified depending on sensor type and output. Op-amp 110 buffers and amplifies incoming changes and outputs a sine wave which has a long wavelength 112 for high load conditions and a shorter wavelength 114 for low load conditions.

This sine wave is input to timer 150 control (pin 5) and the output (pin 3) of timer 150 is triggered on for a longer duration during high rpm/load, a condition which causes current driver 156 to stay on longer. This causes an increased duty cycle, producing longer stimulation periods of the attached electrode(s). For this representative application, variation of current driver 156 “on” time may vary from 44% to 98.6% dependent on timer 150 modulation input.

Furthermore, one-half of op-amp 144 is used as an oscillator to drive a transducer 64 (FIG. 6) attached to any electrode used in electrolysis. Op-amp 162 outputs a signal between 2 Hz and 100 Hz dependent on electrode size and shape. This signal is outputted to transistor 164 to drive the sine or square wave 168 into an electrode-mounted transducer. As discussed above, this signal vibrates the electrode plates, facilitating release of hydrogen from the electrolysis plates in minute-bubbles and micro-bubbles.

It should be noted that the circuit described above has been optimized for 12VDC operation, since this voltage is available from the battery in most automobiles. However, a wide range of voltage sources can be accommodated in an alternate design (e.g., 24 VDC, 48 VDC, etc.). Additionally, the control system could be modified to accept 120 VAC for high volume stationary applications. The combined use of the shaped waveform and ohmic load 66 provides stable current repetition at system turn on and prevents current runaway as the catalysis solutions heat up. Use of this combination also reduces alternative reaction pathways in and on electrodes in electrolysis.

It has further been found, that the electrodes of the present invention provide improved performance when pre-conditioned prior to first use. It is generally known that the performance of new electrolysis electrodes is not the same as electrolysis electrodes that have been used for some time. After a “break-in” period performance of the electrolysis electrode stabilizes to a known level. The length of the break-in period can vary considerably depending on the application, material, and operating power levels. During this break-in period, 1) the shape of the electrode(s) can change resulting in tolerance changes between electrodes (or assemblies); 2) there is inefficient power usage; and 3) measuring system performance (or experimental results) is unreliable.

Therefore, electrolysis electrodes, or any aqueous fluid electrodes, should be pre-conditioned to remove manufacturing oils, imbedded particulate matter, and to form the metal(s) surface. This preconditioning allows the electrolysis reaction process to effect a normal steady state reaction without needing long periods of system run time to achieve a high volume of gaseous output or stable stimulus application. This preconditioning provides electrodes, or electrode assemblies, that are ready to run “out of the box” and immediately provide the highest possible volume of hydrogen gas and a repeatable and stable stimuli.

### Preconditioning Example

The electrode assemblies need to be assembled into their application-specific form. The following procedure is provided for 3 electrode cells connected in parallel, whose normal total current draw is one-half of the pre-conditioning applied current. The procedure should be scaled to the respective number of cells and operational current. No ohmic load or other electronics should be attached during the pre-conditioning process. A regulated DC power supply capable of continuous output of 50-60 amps without voltage drop is needed. The power supply should be capable of maintaining a preset current limit without current runaway.

Mix a catalyst of 108 grams of NaHCO3 (sodium bicarbonate), one fluid ounce H2O2, and one fluid ounce of distilled white vinegar (5% acetic acid) per one gallon of distilled water. Catalyst to water volume ratios should be matched to the electrode(s) container to fully cover the electrode working surface(s) but not larger than necessary so as not to dilute the catalyst. Place the electrodes in an appropriate container to fully cover electrodes with the aqueous catalyst solution. Vent gases per federal or state regulations. For example, the distance between the electrodes working surfaces should be fixed at approximately 0.2 to 0.3 inches. Large flat plate electrodes should be spaced to maintain recommended current application. Apply voltage to electrodes maintaining 16-18 amps per electrode assembly. (i.e.: 3 electrode plate assemblies in parallel with draw about 50 amps at 12 VDC).

The preconditioning process should be run for approximately 20 hours of “on” time. A power off rest cycle of 30 minutes is required when the aqueous solution reaches a temperature of 190-200 degrees F. The catalyst selection may be varied but, in general, 3× the normally used solution should be used. The total time of 20 hours does not include power system off time due to solution temperature rest cycle. In addition, cooling of the solution container by exhaust fans or forced air is recommended. This also reduces rest cycle down time due to aqueous solution temperature rise.

Now that while exemplary embodiments of the present invention have been shown and described in detail, various modifications and improvements thereon will become readily apparent to those skilled in the art. Accordingly, the spirit and scope of the present invention is to be construed broadly and limited only by the appended claims, and not by the foregoing specification.

What is claimed is:

1. An electrolysis control system for generating gases comprising:
an electronic controller including a shaped current waveform generator and a current control device coupled to the output thereof;
at least one electrode assembly disposed within a housing adapted to store an electrolyte solution, each electrode assembly comprising:
an anode coupled to an electrical power source; and
a cathode coupled to the current control device,
wherein the shaped current waveform generator causes the current control device to periodically couple the cathode to ground to pass current though the electrolyte solution and generate gases.

2. The system of claim 1 further comprising a substantially non-inductive load connected, in series, between the cathode and the current control device.

3. The system of claim 1 wherein the shaped current waveform exhibits substantially no overshoot or ringing.

4. The system of claim 1 wherein the shaped current waveform has a frequency of between about 31 kHz and 72 kHz and current control device conducts for a duty cycle of between about 72 percent and about 97.

5. The system of claim 1 wherein the anode is interposed between a first cathode and a second cathode.

6. The system of claim 4 wherein the electrode assembly further comprises one or more plates interposed between the anode and the first cathode and one or more plates interposed between the anode and the second cathode, wherein the plates are not connected to the anode or cathodes.

7. The system of claim 1 further comprising a transducer coupled to the electronic controller and adapted to provide agitation of the electrolyte solution and electrodes.

8. The system of claim 7 wherein the electronic controller is adapted to energize the transducer at approximately 2 to 100 Hertz.

9. The system of claim 1 wherein the housing further comprises an air conduit adapted to provide agitation of the electrolyte solution and electrodes.

10. An apparatus for enhancing the combustion of an internal combustion engine comprising:
an electronic controller including a shaped current waveform generator in communication with one or more engine sensors and a current control device coupled to the output thereof;
at least one electrode assembly disposed within a housing adapted to store an electrolyte solution, each electrode assembly comprising:
an anode coupled to an electrical power source; and
a cathode coupled to the current control device,
wherein the shaped current waveform generator causes the current control device to periodically couple the cathode to ground to pass though the electrolyte solution and generate hydrogen gas.

11. The apparatus of claim 10 further comprising a substantially non-inductive ohmic load connected, in series, between the cathode and the current control device.

12. The apparatus of claim 10 wherein the shaped current waveform exhibits substantially no overshoot or ringing.

13. The apparatus of claim 10 wherein the volume of hydrogen gas produced by the apparatus is proportional to the output of the one or more engine sensors.

14. The apparatus of claim 10 wherein the electrode assembly further comprises a transducer coupled to the electronic controller and adapted to provide agitation of the electrolysis solution and electrodes.

15. The apparatus of claim 14 wherein the electronic controller is adapted to energize the transducer at approximately 2 to 100 Hertz.

16. The apparatus of claim 10 wherein the anode is interposed between a first cathode and a second cathode.

17. The apparatus of claim 16 wherein the electrode assembly further comprises one or more plates interposed between the anode and the first cathode and one or more plates interposed between the anode and the second cathode, wherein the plates are not connected to the anode or cathodes.

18. A method for enhancing the combustion of an internal combustion engine comprising:
receiving, at an electronic controller, an input signal from an engine control system which varies with one or more engine parameters;
generating, in the electronic controller, a shaped current waveform which is proportional to the input signal;
applying the shaped current waveform to a current control device in the electronic controller;
coupling the output of the current control device to an electrode assembly disposed within a housing containing an electrolyte solution, the electrode assembly comprising an anode coupled to an electrical power source and a cathode coupled to the current control device,
periodically coupling the cathode to ground potential to pass current through the electrolyte solution and generate hydrogen gas;
delivering the hydrogen gas to the engine for combustion.

19. The method of claim 18 wherein a substantially non-inductive ohmic load is connected, in series, between the cathode and the current control device.

20. The method of claim 18 wherein the shaped current waveform exhibits substantially no overshoot or ringing.

21. The method of claim 18 wherein the electrodes have been subject to a pre-conditioning process comprising the steps of:
immersing the electrode assembly in an aqueous catalyst solution, comprising about 100 to 120 grams of NaHCO₃, KOH, NaOH or NaCl, about 1 fluid ounce hydrogen peroxide and about one fluid ounce acetic acid, per one gallon of water;
applying a current at a level and for a duration sufficient to remove electrode surface impurities.
